(19) United States
(12) Patent Application Publication
(10) Pub. No.: US 2025/0188292 A1
(43) Pub. Date: Jun. 12, 2025

(54) Gaphene-based coating composition for eletromagnetic interference shielding, methods and uses thereof

(71) Applicant: GRAPHENEST, S.A., Paradela SVV (PT)

(72) Inventors: Bruno REIS FIGUEIREDO, Oliveira do Bairro (PT); Vitor Emanuel MARQUES ABRANTES, Aveiro (PT); Rui Pedro FONSECA FERREIRA DA SILVA, Macinhata do Vouga (PT); João Nuno DUARTE RODRIGUES, Braga (PT)

(73) Assignee: GRAPHENEST, S.A., Paradela SVV (PT)

(21) Appl. No.: 18/843,826

(22) PCT Filed: Mar. 6, 2023
(86) PCT No.: PCT/IB2023/052084

§ 371 Date: Sep. 4, 2024

(30) Foreign Application Priority Data
Mar. 4, 2022 (PT) 117841

(51) Int. Cl. C09D 5/32; C09D 7/20; C09D 7/40; C09D 7/61; C09D 7/65; C09D 183/04

(52) U.S. Cl. CPC C09D 5/32; C09D 7/20; C09D 7/61; C09D 7/65; C09D 7/69; C09D 7/70; C09D 183/04

(57) ABSTRACT

The present application relates to a graphene-based coating composition suitable for electromagnetic interference shielding from 30 MHz to 300 GHz frequencies, in which the composition comprises graphene nanoplatelets. The present invention also relates to a method for applying the ink composition as a coating to a substrate and uses of the ink composition.

### TECHNICAL FIELD

The present disclosure relates to the field of a coating compositions, preferably an ink composition, comprising graphene for electromagnetic interference shielding from 30 MHz to 300 GHz frequencies; to coated article with said composition; methods and uses thereof.

### BACKGROUND

Human-made and natural electromagnetic interference (EMI) sources can cause temporary disturbances, data loss, and failure of electronic devices, equipment, and systems. These problems create many challenges and are of critical importance to the automotive, aerospace, defense, and medical industries.

EMI as risen immensely due to the exponential density growth of electronics which may degrade device performance, adjacent systems and even adversely affect the human health.

Nanotechnology and miniaturization have further aggravated the EMI issue as mutual interference among device's components or chip elements can produce microscopic interference effects. The most common instances of EMI from everyday life are cross-talking of our laptop screen or conference room wireless microphones with mobile-phone signals producing picture flicker or noise distortion. Due to EMI the use of mobile phone is prohibited onboard or inside certain locations or premises. This impelled the development of suitable countermeasures to suppress (or eliminate) EMI effects. Basically, there are three main mechanisms for EMI shielding reflection, absorption, and multiple reflection. Among them reflection, is identified as primary EMI shielding mechanism for which the shield must contain mobile charge carriers (e.g., electrons or holes that can be provided by metallic, offshoot carbon or conducting polymer-based materials). The secondary EMI shielding mechanism is absorption for which shield should possess electric and/or magnetic dipoles which can interact with the electric or magnetic fields in the EM radiation.

The tertiary mechanism is multiple reflection, which is facilitated by high interfacial area. Existing shielding methods that address these issues use brittle, inflexible and heavy systems, as well as rigid enclosures, meshes and foils made from heavy-weight and expensive metals like silver, copper, aluminum and nickel.

Metals are by far the most common materials for EMI shielding owing to their high electrical conductivity. However, they suffered from problems such as high reflectivity, corrosion susceptibility, weight penalty, high carbon footprint, and uneconomic processing. In this consideration, polymer-based blends and composites have attracted enormous attention due to unique combination of electrical, thermal, dielectric, magnetic and/or mechanical properties useful for efficient electromagnetic shielding response.

Nanoscale materials based on single/multi-layered graphene sheets have attracted much attention due to its unusual properties. Graphene is known as the thinnest (one carbon atom thick) yet strongest material (on the basis of specific strength) compared to other carbon allotropes, such as graphite, carbon fibers, fullerenes and CNTs, or conventional metals. In addition, graphene also possesses exceptional electrical and thermal properties making it promising candidate for electronics and EMI shielding applications. Recently with the identification of methods for handing graphene, several attempts have also been made to utilize the fascinating and promising properties of these individual carbon sheets by formation of graphene-based nanocomposites particularly for electrical and electromagnetic shielding applications. The use of graphene, with large aspect ratio and high conductivity would provide a high EMI shielding.

In sum, graphene possesses distinct properties that makes it a promising material for several applications due to having advantages over conventional shielding solutions that are mainly based on metals which are heavy, rigid, and high time and energy intensive. Specifically, its high conductivity capacity may encounter applicability in sensors, batteries, transistors, capacitors, among others.

Structures based on graphene sheets have been the focus of several studies because of their outstanding electrical and mechanical properties. This high conductivity results in thin skin depth, leading to the deterioration of the electromagnetic field caused by absorption loss within the shielding material. Moreover, since the reflection loss at the interfaces between any two materials is dependent on the difference between the characteristic impedance of the shield and surrounding material, a high electrically conductive material is required (Henry W. Ott, Electromagnetic Compatibility Engineering. John Wiley & Sons, 2011.) From the viewpoint of absorption and reflection losses, graphene may be an optimal shielding material. In addition, because of its mechanical properties, graphene has been considered a promising candidate as an EMI shield (C. Acquarelli, a Rinaldi, a Tamburrano, G. De Bellis, a G. D. Aloia, and M. S. Sarto, pp. 488493, 2014). Compared to traditional metal shields, graphene itself is robust, lightweight, and flexible, so it has the potential for commercial applications (J. Liang, Y. Wang, Y. Huang, Y. Ma, Z. Liu, and J. Cai, vol. 47, no. 3, pp. 922925, 2008).

Graphene-based conductive coatings have emerged as an effective solution to replace metallic coatings, foils, meshes, and enclosures, with a lighter, flexible coating.

Document CN103113786A discloses a graphene conductive ink and preparation method thereof that can be used for electrical purposes including EMI shielding. However, this document describes the use of polycarbonate and an overall different formulation. Additionally, the document CN103113786A claims an application range of graphene weight percent from 0.1-95%, unveiling what can be considered an ineffective ink for the shielding application purpose.

Document CN105001716A discloses graphene-based low resistance conductive printing ink and preparation method thereof without a full application disclosure while using a more complex ink formulation, namely the usage of 5-20 wt % of a certain auxiliary conductive agent.

Document EP3703479A1 discloses a composite material for shielding electromagnetic radiation, raw material for additive manufacturing methods and a product comprising the composite material as well as a method of manufacturing the product.

These facts are disclosed in order to illustrate the technical problem addressed by the present disclosure.

### GENERAL DESCRIPTION

The present disclosure relates to a graphene-based composition for electromagnetic interference shielding from 30 MHz to 300 GHz frequencies. Preferably, it relates to a graphene-based coating composition.

Additionally, the present disclosure also offers customized electrical conductivity and wave attenuation levels. This coating can be applied to flexible or rigid materials on smooth or uneven surfaces by using conventional spray, brushing techniques, spray coating, paint brushing, roll coating, barcoating, dropcasting, bladecoating, doctor blade, dipcoating, screen printing and spincoating.

The composition of the present disclosure is also suitable to be applied in parasitic elements, board level shielding, patches and thin films.

The composition of the present disclosure comprises the following advantages:
more than 75% reduction in weight by replacing heavy metal shielding with lightweight polymers;
excellent conductivity with planar electrical resistance from 0.01 to 500 Ohm/sq;
more than 95% attenuation within radio and microwave frequency range between 30 MHz and 300 GHz;
good adhesion to rigid, flexible, smooth, uneven, and soft materials.

The present disclosure allows the use of graphene to a wide range of manufacturing industries and technological areas including aerospace & defence, telecommunications & IT, energy, healthcare, consumer electronics, automotive, packaging, maritime, sports & protective equipment, and biotech.

The composition can be applied as an EMI shielding coating to industrial equipment, electronic parts, medical devices, communication devices, office devices, military devices, automotive components, aerospace devices, EMI/RFI shielding enclosures, automobile cables, RFID Tags, solar panels, consumer electronics, mobile and flexible electronics, conductive paint, medical devices, sensors, wearable electronics and touch screens are some of the application examples.

The present disclosure relates to a graphene-based coating composition for electromagnetic interference shielding from 30 MHz to 300 GHz frequencies comprising:
1 0.1 to 30 wt. % of graphene as a first carbon-based material;
0.1 to 30 wt. % of a second carbon-based conductive material;
Oto 20 wt. % of a dispersant agent, preferably alkoxysilane;
0.1 to 40 wt. % of a polymer as a binder is selected from a list of: silicone-based polymer, polyetherimide, polysiloxane, polyethylenimine, ethylcellulose, or their mixtures;
0.1 to 10 wt. % of polyoxyethylene;
10 to 85 wt. % of a solvent is selected from a list consisting of: xylene, kerosene, toluene, water, dimethylsulfoxide, butanone, diethylene glycol monoethyl ether acetate, cirene, tetrahydrofuran, ethanol, polyacrylic acid, polyvinyl acid, terpineol; or mixtures thereof.

The graphene-based coating composition of the present disclosure allows with this combination of materials that surprisingly the dispersion of graphene and other conductive fillers is stable, promoting the electrical percolation, which will ensure an improved electrical conductivity for application of this coating composition as an electromagnetic shield.

In an embodiment, the binder has an influence on the level of conductivity and EMI shielding. Furthermore, different binders (or mixtures) have different adhesion behaviour to different substrates. Preferably, the polymer used as a binder is a silicone-based polymer. For better results, the binder is polysiloxane, more preferably polydimethylsiloxane.

In the graphene-based coating composition of the present disclosure the polyoxyethylene acts as a surfactant; the alkoxysilane is a dispersant agent and the xylene is a solvent.

In an embodiment for better results, the solvent ranges from 20 to 60 wt. %; preferably 20 to 50 wt. %; more preferably 20 to 30 wt. %.

In an embodiment for better results, the solvent is selected from a list consisting of xylene, water, or mixtures thereof; preferably xylene.

In an embodiment for better results, the graphene is selected from: nanoplatelet graphene, few-layer graphene, multi-layer graphene; oxide graphene, or combinations thereof. In an embodiment for better results, the graphene is nanoplatelet graphene.

In an embodiment for better results, the graphene nanoplatelets have a diameter particle size between 1 μm and 25 μm; preferably 0.3-8 μm.

In an embodiment for better results, the graphene nanoplatelets D50 size of 2.0 μm and D90 size of 7.8 μm.

In an embodiment for better results, the graphene flake thickness is less than 100 nm; more preferably 0.33-15 nm. The measure was made with scanning electron microscopy (SEM) and transmission electron microscopes (TEM).

In an embodiment, the graphene nanoplatelets have an average size from 1.0 to 10.0 μm, preferably from 2.0 to 6.0 μm, more preferably 4.0 μm. The measure was made with scanning electron microscopy (SEM).

In an embodiment for better results, the amount the polymer ranges from 1 to 40 wt. %; preferably from 10 to 35 wt. %; more preferably 15-25 wt. %.

In an embodiment for better results, the polymer is polysiloxane.

In an embodiment for better results, the polysiloxane is polydimethylsiloxane.

In an embodiment for better results, the amount of alkoxysilane ranges from 0.1 to 20 wt. %; preferably 0.2 to 10 wt. %; 0.5 to 5 wt. %.

In an embodiment for better results, the second carbon-based conductive material is selected from a list consisting of: graphite, carbon black, carbon nanotubes, carbon nano onions, graphene oxide, carbon nanospheres, and mixtures thereof.

In an embodiment for better results, the polyoxyethylene is polyoxyethylene 10 tridecyl ether. Polyoxyethylene 10 Tridecyl Ether is nonionic surfactant and is an effective wetting agent.

In an embodiment for better results, the alkoxysilane is (3-Aminopropyl) triethoxysilane.

Another aspect of the present disclosure relates to an ink comprising the composition of the present disclosure.

Another aspect of the present disclosure relates to a coated article comprising the graphene- based coating composition of the present disclosure. Preferably the coated article is an industrial equipment, electronic parts, medical devices, communication devices, office devices, military devices, automotive components, aerospace and defence devices, EMI/RFI shielding enclosures, cables, RFID tags, solar panels, consumer electronics, mobile devices and flexible electronics, sensors, wearable electronics, touch screens, in parasitic elements, board level shielding, patches and thin films.

In an embodiment for better results, the thickness of the coating composition ranges from 15 to 20000 μm; preferably 50-500 μm; 100-300 μm.

In an embodiment for better results, the thickness of the coating composition ranges from 100 to 250 μm.

Another aspect of the present disclosure relates to a process for obtaining the graphene-based coating composition of the present disclosure comprising the steps of:
mixing of a polymeric binder in a solvent,
adding graphene to the mixture;
adding of a second carbon-based conductive material to the mixture, and
adding of polyoxyethylene to the mixture;
wherein
the polymer as a binder is selected from a list of: silicone-based polymer, polyetherimide, polysiloxane, polyethylenimine, ethylcellulose, or their mixtures and ranges from 0.1 to 40 wt. %; the graphene ranges 1 to 30 wt. %;
the second carbon-based conductive material ranges from 0.1 to 30 wt. %;
the polyoxyethylene ranges from 0.1 to 10 wt. %;
the solvent is selected from a list consisting of: xylene, kerosene, toluene, water, dimethylsulfoxide, butanone, diethylene glycol monoethyl ether acetate, cirene, tetrahydrofuran, ethanol, polyacrylic acid, polyvinyl acid, terpineol; or mixtures thereof and ranges from 10 to 85 wt. %.

In an embodiment for better results, the process further comprises the step of adding a dispersant, preferably 0.1 to 20 wt. % of alkoxysilane to the mixture.

Another aspect of the present disclosure relates to a method for applying the graphene-based coating composition described in the present disclosure or obtained by the method described in the present disclosure comprising the step of: applying the coating composition to a substrate by spray coating, paint brushing, roll coating, spincoating, bladecoating, barcoating, doctor blade, dipcoating screen printing or dropcasting techniques; curing the coating layer by heating at a temperature up to 250° C.; preferably by air drying.

In an embodiment, the graphene-based coating composition for electromagnetic interference shielding from 30 MHz to 300 GHz frequencies comprising:
Graphene nanoplatelets between 0.1 and 30 wt. %;
Other carbon-based material between 0.1 and 30 wt. %;
Alkoxysilanes between 0.1 and 20 wt. %;
A polysiloxane or another silicone-based polymer between 0.1 and 40 wt. %;
A Polyoxyethylene between 0.1 and 10 wt. %;
A xylene compound between 10 and 30 wt. %.

In one embodiment the graphene nanoplatelets have a distribution of particle size from 1 μm to 25 μm and flake thickness of less than 100 nm.

In one embodiment the polysiloxane is polydimethylsiloxane.

In one embodiment the carbon-based material is selected from natural and synthetic graphite, carbon black, carbon nanotubes, carbon nano onions, graphene oxide and carbon nanospheres.

In one embodiment the Polyoxyethylene is Polyoxyethylene 10 tridecyl ether.

In one embodiment the composition further comprises solvents selected from kerosene, toluene, water, dimethylsulfoxide, butanone, diethylene glycol monoethyl ether acetate, cirene, tetrahydrofuran, ethanol, polyacrylic acid, polyvinyl acid, terpineol, or their mixtures.

In one embodiment the solvent is present in a range between 0.1 and 85 wt. %.

In one embodiment the composition further comprises a polymer selected from polyetherimide, polysiloxane, polyethylenimine, ethylcellulose, or their mixtures.

In one embodiment the polymer is present in a range between 1 and 40 wt. %.

In one embodiment the composition further comprises an additive selected from alkoxysilanes such as (3-Aminopropyl) triethoxysilane.

In one embodiment the additive is present in a range between 1 and 20 wt. %.

In one embodiment the composition is for use as a coating for industrial equipment, electronic parts, medical devices, communication devices, office devices, military devices, automotive components, aerospace and defence devices, EMI/RFI shielding enclosures, cables, RFID tags, solar panels, consumer electronics, mobile devices and flexible electronics, sensors, wearable electronics, touch screens, in parasitic elements, board level shielding, patches and thin films.

In one embodiment the coating has a thickness between 15 and 20000 um, preferably 50-500 μm; more preferably 100-300 μm.

The present description also relates to a method of applying the composition as a coating by spray coating, paint brushing, roll coating, spincoating, bladecoating, barcoating, doctor blade, dipcoating screen printing or dropcasting techniques, and then air dried or cured by heating at a temperature up to 250° C.

The composition of the present disclosure features remarkable attributes such as:
Long shelf-life when stored under cool temperatures.
Ready-to-use after hand stirring.
Compatible with several techniques: spray coating, bladecoating, barcoating, doctor blade, paint brushing, roll coating, dropcasting, dipcoating, screen printing and spincoating.
Can be dried at room temperature (RT).
Low surface resistivity.

### BRIEF DESCRIPTION OF THE DRAWINGS

The following figures provide preferred embodiments for illustrating the disclosure and should not be seen as limiting the scope of invention.

FIG. 1: Representation of embodiments where a-b) are optical images of the exfoliated graphene nanoplatelets (GNP) and c-g) are scanning electron microscopy (SEM) images of the same type of exfoliated GNPs drop-casted on a Si substrate.

FIG. 2: Graphic representation of an embodiment of GNPs lateral size histogram, dimensions of 160 individual flakes measured from the SEM images.

FIG. 3: Bright field-transmission electron microscopy (BFTEM) images of GNPs. The insets in a) and c) represent the regions where b) and d) images were captured.

FIG. 4: a) Raman spectra (average of 15 spectra, normalized to G peak) of the pristine as-received graphite (4a) and exfoliated GNPs powder (4b). b) Detailed view of the D, G and D′ peaks and corresponding Lorentzian fits. C) Detailed view of the 2D peak, fitted with 3 Lorentzians.

FIG. 5: X-ray photoelectron spectroscopy (XPS) spectra of graphite (5a) and GNPs (5b) powders. a) Survey spectra, normalized to the highest intensity; b) High-resolution C 1 s spectra.

FIG. 6: Optical images of the GNPs from different commercially available materials: a) K1; b) K2; c) F1; d) F2.

FIG. 7: Raman spectroscopy spectra (normalized to the maximum intensity peak, G band) of GNP powders from commercially available materials: a) an embodiment of the graphene-base composition of the present disclosure; b) is K1; c) is K2; d) is F1; e) is F2.

FIG. 8: High-resolution C 1 s XPS spectra of a reference pristine graphite (a) and GNP powder samples from 3 commercially available materials: Graphenest ((b) Present invention), c) K1; d) K2) and e) F1; f) F2. All spectra were individually normalized to the highest intensity value.

FIG. 9: a) Sample of COATING #A (or INK A) blade coated on a Mylar substrate. b) Optical image of the cross-section of a standalone COATING #A, revealing its heterogeneous nature, with the brighter regions corresponding to the polymeric matrix. c-f) SEM images of the surface of COATING #A.

FIG. 10: COATING #A Fourier transform infrared spectroscopy (FTIR) spectra. The numbers in the figure represent functional groups associated with PDMS. The weak peaks near 2850, 1794 and 1571 cm⁻¹ correspond respectively to the symmetric C—H stretching (a) C═O stretching vibrations (b) and C═C aromatic ring (c).

FIG. 11: Variation of the EM attenuation (right y-axis, EM reflection (a), EM absorption (b) and total EM attenuation (c)) and surface resistivity (left y-axis, Rsheet (d)) with COATING #A thickness. The EM attenuation was calculated from the average values of the S-parameters measured with a VNA, up to 3 GHz.

FIG. 12: a) to i) shows an overview of the TEM images of graphene flakes.

FIGS. 13, 14, 15 and 16 show the TEM images of graphene material used for morphology analysis.

### DETAILED DESCRIPTION

The present application relates to a graphene-based coating composition, preferably an ink composition, suitable for electromagnetic interference shielding from 30 MHz to 300 GHz frequencies, in which the composition comprises graphene nanoplatelets. The present invention also relates to a method for applying the ink composition as a coating to a substrate/article and uses of the ink composition.

Now, preferred embodiments of the present disclosure will be described in detail with reference to the annexed drawings. However, they are not intended to limit the scope of this application.

The present disclosure relates to a coating composition, preferably an ink composition, comprising graphene for electromagnetic interference shielding from 30 MHz to 300 GHz frequencies.

Following will be shown a graphene characterization

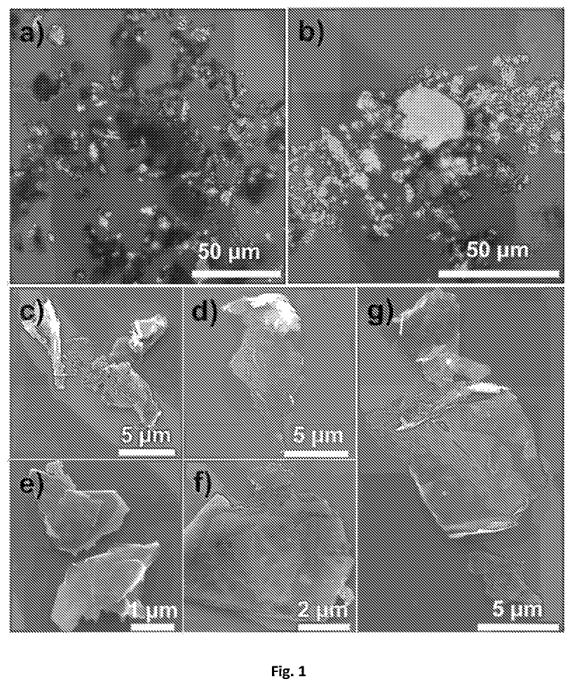

An optical image is shown in FIG. 1a and 1b and it is possible to observe exfoliated nanoplatelets with different dimensions and morphologies. Further investigation with scanning electron microscopy (SEM) (FIGS. 1c-g) and surface analysis at higher resolution shows a layered structure of graphene nanoplatelets (GNPs) with folded edges.

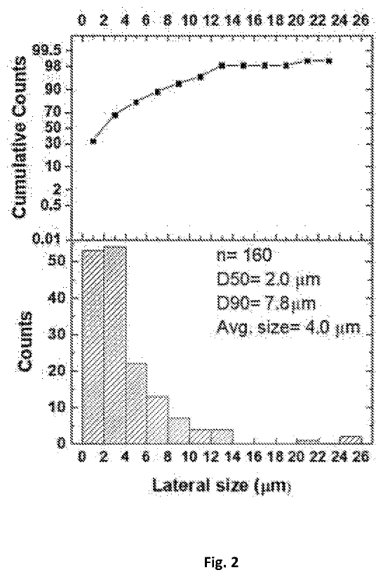

In an embodiment, FIG. 2 shows the lateral size measurement of 160 flakes. It was possible to calculate the GNPs average size of 4.0 μm, with 50% of the flakes being smaller than 2.0 μm and 90% smaller than 7.8 μm.

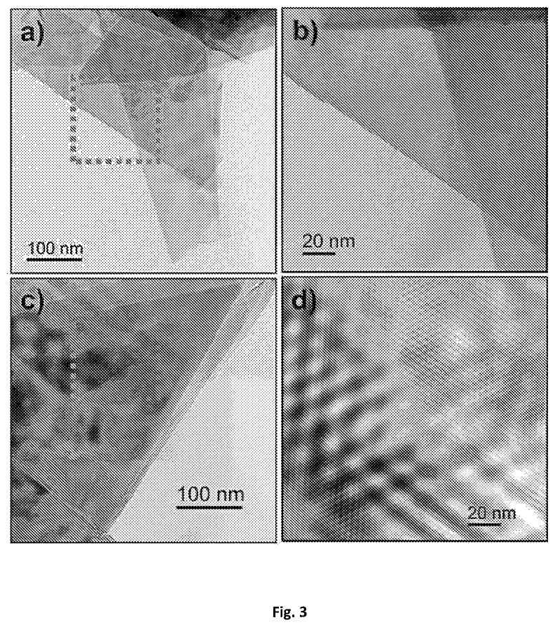

In an embodiment, with bright-field (BF) TEM is possible to see overlapped layers of the graphene flakes suspended on carbon-holey grids (FIG. 3a-c). FIG. 3d shows a captured image with higher magnification where it is visible the overlap of several folded nanosheets, presenting a moiré pattern which arises from the crystalline mismatch.

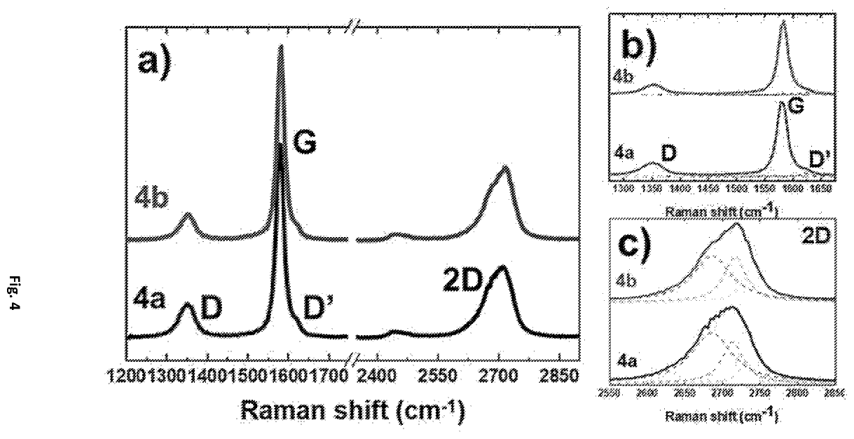

Raman spectroscopy of the original graphite powder and the after-exfoliation GNPs powder can be seen in FIG. 4. A detailed view of the peaks and corresponding fittings can be seen in FIGS. 4b and 4c, where due to the fewlayer/multilayer nature of the samples the fitting of the 2D peak must be done with 3 individual Loretzians, as opposed to the characteristic single symmetric Loretzian shape for a single layer graphene.

The values of the characteristic peaks position, Full Width and Half Maximum (FWHM) and intensity ratios are shown in Table 1. The characteristic D, G and 2D modes of graphite appear at 1350.9, 1581.0 and 2703.6 cm⁻¹, respectively. Comparing the GNPs to the graphite, there are no significant changes in peak position or shape besides a small decrease of the D/G band intensity ratios from 0.18 to 0.14. The low D band intensity suggests the absence of defects and a rather large crystal size. This feature can be associated with edges effects, that are more easily observed in extensively exfoliated graphene with small sheets sizes (A. C. Ferrari, J. C. Meyer, V. Scardaci, C. Casiraghi, M. Lazzeri, F. Mauri, S. Piscanec, D. Jiang, K. S. Novoselov, S. Roth, A. K. Geim, 187401 (2006); M. Lotya, Y. Hernandez, P. J. King, R. J. Smith, V. Nicolosi, L. S. Karlsson, F. M. Blighe, S. De, Z. Wang, I. T. McGovern, G. S. Duesberg, J. N. Coleman, J. Am. Chem. Soc. 131 (2009) 3611-3620).

TABLE 1
Raman peaks characteristics of the GNPs powders of an embodiment of the graphene-based
coating composition, extracted from the fitting of the peaks using single Lorentzians.

| | Pos._{D} | FWHM_{D} | Pos._{G} | FWHM_{G} | Pos._{D′} | FWHM_{D′} | Pos._{2D} | FWHM_{2D} | | |
|---|---|---|---|---|---|---|---|---|---|---|
| Sample | (cm⁻¹) | (cm⁻¹) | (cm⁻¹) | (cm⁻¹) | (cm⁻¹) | (cm⁻¹) | (cm⁻¹) | (cm⁻¹) | I_{D}/I_{G} | I_{2D}/I_{G} |
| Graphite | 1350.9 | 45.7 | 1581.0 | 21.5 | 1622.7 | 11.8 | 2703.6 | 76.9 | 0.18 | 0.37 |
| GNP | 1352.5 | 41.3 | 1582.8 | 19.7 | 1623.5 | 12.3 | 2708.0 | 74.7 | 0.14 | 0.39 |

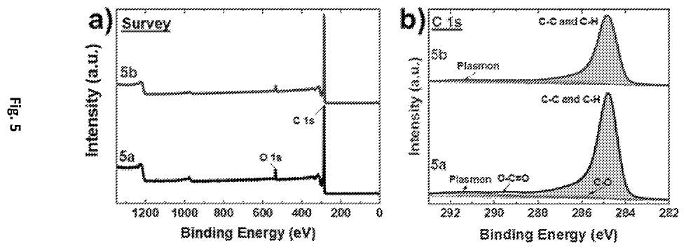

With X-ray photoelectron spectroscopy (XPS) it is possible to characterize the material's surface chemistry with extreme selectivity. For carbon-based materials it is especially useful to quantify the amount of oxygen groups and identify different functional groups. The XPS spectra of both pristine graphite (a) and GNP (b) powders didn't contain any elements beyond carbon and oxygen, revealing the absence of impurities or contaminations. From the normalized Survey spectra from FIG. 5a and Table 2 it is possible to notice a small decrease of the O 1 s peak when the graphite was exfoliated to GNPs, from 5.4% to 4.9%. FIG. 5b shows a high-resolution spectra of the C 1 s peak from the same samples. Besides the characteristic asymmetric peak assigned to C—C and C—H bondings, a small peak at 248.8 eV attributed to O—C═O groups was detected on the graphite sample (a) but not on the GNP powder (b). Secondary peaks corresponding to plasmon/shake-up features were also detected at higher binding energies, around 291 eV. The values for binding energy, FWHM and atomic percentage of the fitted peaks from FIG. 5b are shown Table 3. No significant peak shifts were detected, thus reinforcing the proposition that the exfoliation process does not introduce new functional groups/contaminations neither alter the material's chemistry.

TABLE 2
C 1s and O 1s values for binding energy, full width
at half maximum (FWHM) and atomic percentage, acquired
from the survey spectra from FIG. 5a of both graphite
and GNP samples of the present disclosure.

| Survey | | Peak BE (eV) | FWHM (eV) | Atomic % |
|---|---|---|---|---|
| Graphite | C 1s | 284.8 | 2.9 | 94.6 |
| | O 1s | 532.8 | 3.8 | 5.4 |
| GNP | C 1s | 284.8 | 1.9 | 95.1 |
| | O 1s | 532.8 | 54.1 | 4.9 |

TABLE 3
XPS fitted peaks percentages as acquired from
the high-resolution C 1s spectra from FIG. 5b.

| C1s | | Peak BE (eV) | FWHM (eV) | Atomic % |
|---|---|---|---|---|
| Graphite | C—C, C—H | 284.8 | 1.03 | 90.9 |
| | C—O | 285.7 | 3.5 | 1.4 |
| | O—C═O | 289.3 | 0.9 | 1.0 |
| | Plasmon | 291.4 | 0.9 | 6.8 |
| GNP | C—C, C—H | 284.8 | 1.1 | 94.3 |
| | Plasmon | 291.0 | 3.0 | 5.7 |

The thermal stability of the GNP powder of the present disclosure was determined by TGA, the percentual mass loss is shown in Table 2. The structural and chemical properties (e.g: particles size/thickness, defects, presence of functional groups and content level of oxygen) of carbon-based powder can influence the TGA features. For instance, graphene oxide (GO), usually present two to three significant mass-loss events for temperatures under 300° C., that can be explained by water elimination (<100° C.) and removal of oxygen functional groups (100-360° C.) (F. Farivar, P. L. Yap, R. U. Karunagaran, D. Losic, C 2021, Vol. 7, Page 41. 7 (2021). In the GNP sample of the present invention these events weren't observed, as expected, with a ˜2% mass loss for temperatures below 100° C., following an almost linear mass change behavior up to 250° C. This result is in accordance with other GNPs powders as reported by Hack et al. (R. Hack, C. H. G. Correia, R. A. de S. Zanon, S. H. Pezzin, Matéria (Rio Janeiro). 23 (2018)).

TABLE 4
TGA analysis of GNP powder of the present disclosure.

Mass loss

| | 0.5% | 2% | 5% | 10% |
|---|---|---|---|---|
| Temperature (° C.) | 51.0 | 99.5 | 164.6 | 252.2 |

Following will be shown a comparison with other commercial graphene nanoplatelets.

Samples from different commercially available materials, namely K1, K2, F1 and F2 (comparative data), listed in Table 5. K1 corresponds to K-Nano (KNG-150) from K-NANO. KNG-150 graphene nanoplatelets are stacks of multi-layered graphene sheets having a platelet morphology. K2 corresponds to TA-001A. TA-001A consists of large numbers of single-layer sheets and a few few-layer graphenes. F1 corresponds to PureGRAPH™ 5 from FirstGraphene and is characterized by their large platelet size, F2 corresponds to PureGRAPH™ 10 from FirstGraphene and is characterized by being a graphene nanoparticle.

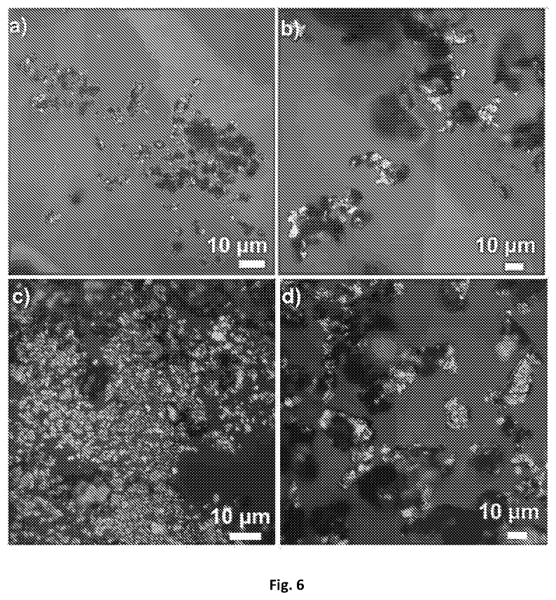

From the optical inspection shown in FIG. 6, it was possible to ascertain that K1 (a) and F1 (c) provide smallest flakes, mostly below the 5um lateral size. The dimensions of K2 (b) and F2 (d) are similar, with the latest looking slighter bigger in size and thickness. These conclusions are in accordance with the available data from the suppliers, listed in Table 5.

TABLE 5
Comparison of thickness and lateral sizes of samples from different
suppliers. Data from an embodiment of GNPs was obtained from the
characterizations shown in the previous section, while other samples'
data was collected from the suppliers' websites and datasheets.

| | | Lateral size |
|---|---|---|
| Sample | Thickness range | (μm) |
| Present invention | Multilayer | 1-25 |
| GNPs | (>10 layers) | |
| K1 | 5-15 nm | 3-6 |
| | (Multilayer, >10 layers) | |
| K2 | 1-3 layers | 5-8 |
| F1 | N.A. | ~5 |
| F2 | N.A. | ~10 |

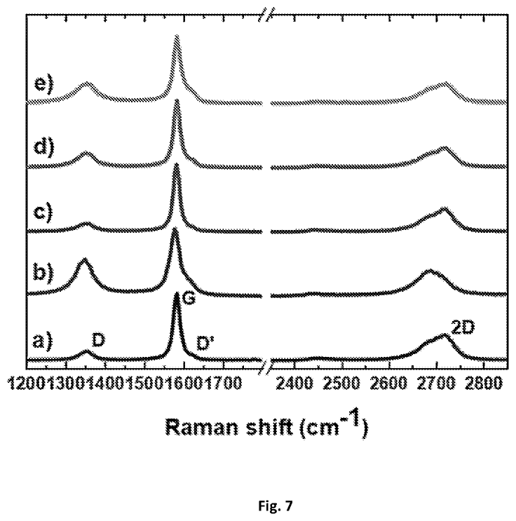

By comparing the Raman spectroscopy of all samples (FIG. 7), the low D-peak intensity and slightly higher I2D/IG ratio of an embodiment of the present disclosure GNPs is highlighted. Still, all spectra are quite similar and characteristic of multilayered GNPs, with the exception of K1 (a), where the small lateral dimensions of the flakes have a major impact on the D and D′ peak intensities and due to the lower flake thickness the shape of the 2D band reflects a few-layer (2-5 layers) thickness (D. Yoon, H. Moon, H. Cheong, J. S. Choi, J. A. Choi, B. H. Park, J. Korean Phys. Soc. 55 (2009) 1299-1303), despite the supplier stating that it should be multilayer (>10 layers).

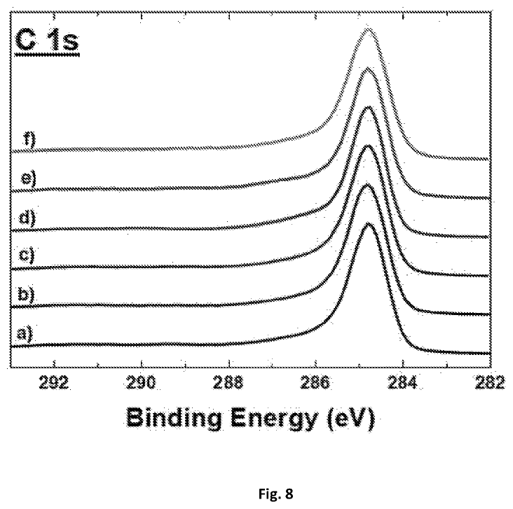

The chemical and structural properties of the GNP samples of the present invention were compared with XPS, with no elements besides C and O detected. The high-resolution C 1 s spectra (FIG. 8) shows the similarity of all plots, with no O-containing functional groups detected. The only divergence between samples was the percentage of oxygen detected. K1 and K2 samples have around 4-5% of oxygen, similar to the present invention's GNPs, while F1 and F2 samples contain a higher level, between 8 and 9%, as seen in Table 6. This could be linked to different factors such as different production methods, used solvents/liquid media and raw graphite characteristics. A graphene with low oxygen content can be linked to better electrical properties (C. Mattevi, G. Eda, S. Agnoli, S. Miller, K. A. Mkhoyan, O. Celik, D. Mastrogiovanni, G. Granozzi, E. Carfunkel, M. Chhowalla, Adv. Funct. Mater. 19 (2009) 2577-2583.)

TABLE 6
XPS data acquired from the Survey spectra of
K1 and K2 and F1 and F2 GNPs. No other elements
besides carbon and oxygen were detected.

| Sample | | Peak BE (eV) | FWHM (eV) | Atomic % |
|---|---|---|---|---|
| K1 | C 1s | 284.8 | 2.7 | 95.4 |
| | O 1s | 532.7 | 3.9 | 4.6 |
| K2 | C 1s | 285.2 | 2.7 | 95.8 |
| | O 1s | 533.6 | 3.4 | 4.2 |
| F1 | C 1s | 284.4 | 1.6 | 91.6 |
| | O 1s | 532.1 | 3.6 | 8.3 |
| F2 | C 1s | 284.9 | 2.8 | 91.0 |
| | O 1s | 532.3 | 3.7 | 9.0 |

In an embodiment, the graphene material used in the presently disclosed coating composition is in the form of nanoplatelets with a distribution of particle size between 1 μm to 25 μm (as shown previously in FIG. 2) and flakes' thickness below 100 nm.

Table 7 shows the particle lateral size distribution of a graphene sample used at the present invention.

TABLE 7
Particle lateral size distribution in a sample of the
graphene nanoplatelets of the present invention.
Particle lateral size distribution

| <3 μm | 3-7 μm | 7-15 μm | >15 μm |
|---|---|---|---|
| 51.9% | 32.5% | 13.8% | 1.9% |

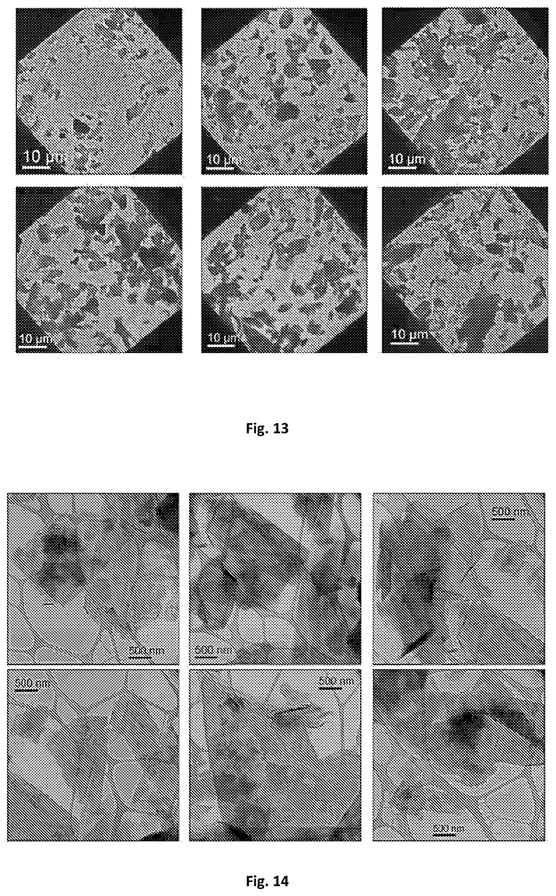

FIG. 12 a) to i) show an overview of the TEM images of graphene flakes. These TEM images reveal a particle size of approximately 5 μm with a dark contrast zone that reveals a different thickness as well as folded flakes which can induce an increase reading in particle thickness. It also showcases several overlapped twisted flakes having different crystallography orientation and presenting a moiré effect.

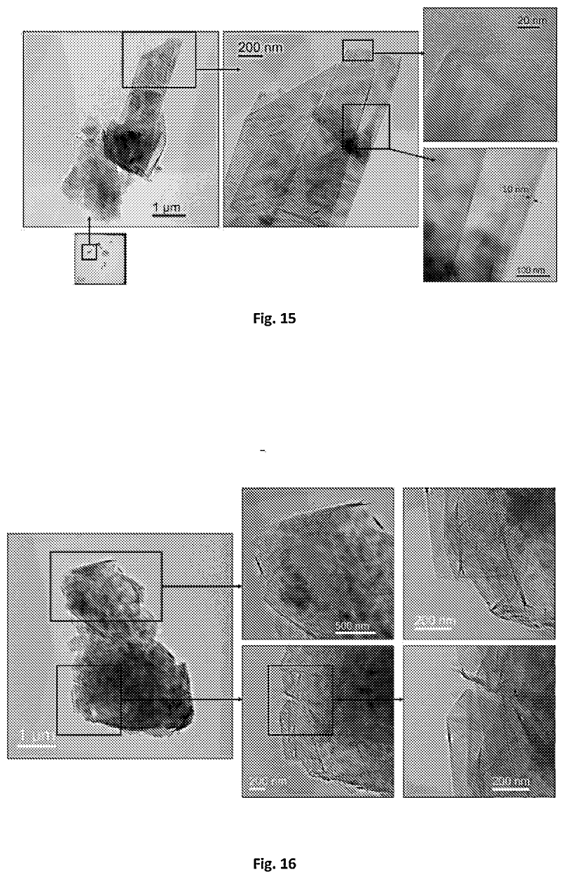

FIG. 13 shows an overview of different sections of the graphene material, where further morphology analysis was carried out in the particles type transparent.

FIGS. 14, 15 and 16 show the TEM images of graphene material used for morphology analysis. FIG. 15 shows the graphene material where it is possible to observe that some graphene flakes are elongated with rod morphology. Some graphene particles, such as the ones shown in FIG. 16, have shown to be formed by a folded flake, i.e., the same flake is folded several times forming a zigzag morphology. As shown in FIG. 16, the particle size was measured at approximately 5 μm. The dark contrast revealed that there is thickness difference and that the folded flakes induce an increase in particle thickness. The graphene sample comprised a distribution of particle size between 1 μm to 20 μm, with flake thickness of less than 10 nm. Small grains were formed from the detached flakes of the large grains and the thickness of the small particles is related to how the flake is folded, i.e., number of times it is folded.

In one embodiment approximately 90% of the graphene nanoplatelets have a lateral size range between 0.3 and 8 μm. The smaller the particles, higher the overall surface area, and thus less graphene is needed to attain the percolation threshold. Smaller particles also allow smaller viscosities which would be a good feature for coatings applications.

Following will be shown an embodiment of the COATING composition

In an embodiment, the COATING #A (OR INK #A) composition comprises:
Graphene nanoplatelets-2 wt. %;
Graphite—6 wt. %;
Alkoxysilane—0.5 wt. %;
Polysiloxane—21.5 wt. %;
Polyoxyethylene—20 wt. %;
Xylene—50 wt. %.

In an embodiment, the COATING #B (OR INK #B) composition comprises:
Graphene nanoplatelets—15 wt. %;
Carbon Black—2 wt. %;
Polytherimide—23 wt. %;
Water—60 wt. %.

In an embodiment, the COATING #C (OR INK #C) composition comprises:
Graphene nanoplatelets—10 wt. %;
Carbon nanotubes—3 wt. %;
Alkoxysilane—2 wt. %;
Polysiloxane—28 wt. %;
Polyoxyethylene—27 wt. %;
Xylene—30 wt. %.

The coating compositions (inks) can generally be prepared by using mixing apparatus.

In an embodiment, the graphene-based composition of the present disclosure for EMI shielding comprises the following compounds:
graphene nanoplatelets between 0.1 and 30 wt. %;
other carbon-based material between 0.1 and 30 wt. %;
alkoxysilanes between 0.1 and 20 wt. %;
a polysiloxane or another silicone-based polymer between 0.1 and 40 wt. %;
a polyoxyethylene between 0.1 and 10 wt. %;
a xylene compound between 10 and 30 wt. %.

In one embodiment polysiloxane is Polydimethylsiloxane (PDMS).

In one embodiment the carbon-based material is selected from natural and synthetic graphite, carbon black, carbon nanotubes, carbon nano onions, graphene oxide and carbon nanospheres.

In one embodiment the xylene compound is a mixture for xylene and ethylbenzene. In one embodiment the polyoxyethylene is polyoxyethylene 10 tridecyl ether.

In one embodiment, the composition, preferably ink, further comprises solvents selected from, but not limited to, kerosene, toluene, water, dimethylsulfoxide, butanone, diethylene glycol monoethyl ether acetate, cirene, tetrahydrofuran, ethanol, polyacrylic acid, polyvinyl acid, terpineol, or their mixtures.

The solvent is present in a range between 0.1 and 85 wt. %.

In one embodiment, the composition further comprises a polymer binder selected from, but not limited to, polyetherimide, polysiloxane, polyethylenimine, ethylcellulose, or their mixtures.

The polymer is present in a range between 1 and 40 wt. %; preferably 10-35 wt. %.

In one embodiment, the composition comprises an additive selected from, but not limited to, alkoxysilanes such as (3-aminopropyl) triethoxysilane.

The additive, namely alkoxysilane is present in a range between 0.1 and 20 wt. %; preferably 0.2-5 wt. %.

Following will be shown a Coating characterization, preferably Ink characterization.

Due to the excellent electrical and thermal properties of GNPs, its use as a conductive additive and filler in coatings, preferably inks, can be beneficial to several applications, including sensors, batteries, medical devices, electromagnetic interference (EMI) shielding, electrical vehicles/automotive and aerospace.

The composition of the present disclosure is a paintable coating, ideal to be used for EMI shielding.

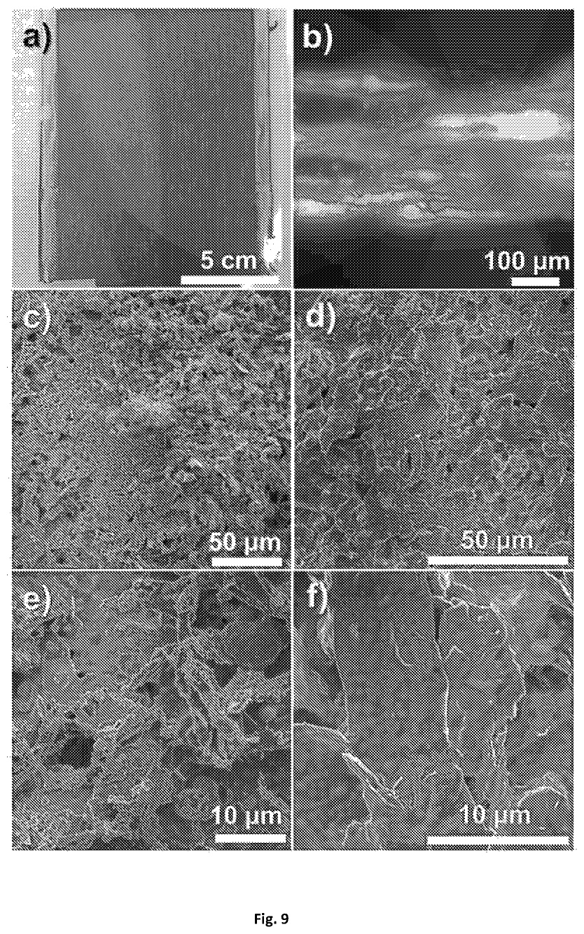

In an embodiment, FIG. 9a shows an example of a RT-dried COATING #A (or INK #A) layer blade coated on a Mylar substrate. Inspecting the cross-section of this layer (FIG. 9b), it is possible to observe the heterogeneous domains of the coating. The polymeric matrix can be seen as the high contrast and bright regions, allowing the formation of a thick and structurally integral coating, as well as enclosing the GNPs in continuous pathways and forming a conductive network, allowing to achieve electrical percolation.

By inspecting the coating surface under SEM (FIG. 9c-f), the flakes can be seen to be quite packed and interconnected, with no visible defects or gaps in the layer. When looking at a graphene flake at higher magnification (FIG. 9f), a globular-like surface texture is observed, possibly caused by the solvent evaporation, forming air pockets in the polymeric passivation coating of the graphene flakes.

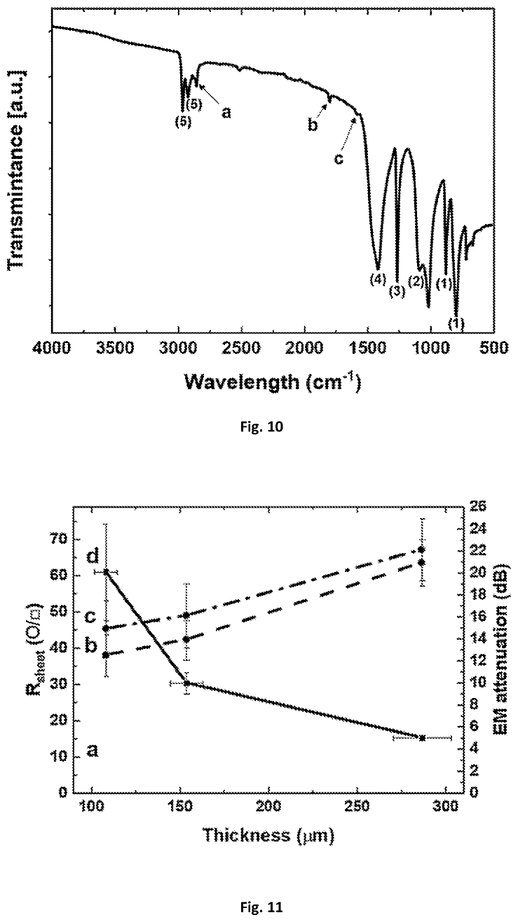

In an embodiment, FIG. 10 shows the FTIR spectra of COATING #A (or INK #A). FTIR provides evidence for the presence of silicon and oxygen-containing functional groups attached to the graphene- based material. The numbers in the figure represent the functional groups associated with PDMS, as listed in Table 8. The weak peaks near 2850, 1794 and 1571 cm⁻¹ correspond respectively to the symmetric C—H stretching (a), C═O stretching vibrations (b) and C═C aromatic ring (c).

TABLE 8
Functional groups from the PDMS matrix
of COATING #A (OR INK #A).

| PEAK | Functional group | Wavelength (cm⁻¹) |
|---|---|---|
| (1) | Si—C stretching and CH₃ rocking | 791 |
| | | 872 |
| (2) | Si—O—Si stretching | 1082 |
| (3) | CH₃ symmetric deformation of Si—CH₃ | 1257 |
| (4) | CH₃ asymmetric deformation of Si—CH₃ | 1410 |
| (5) | CH stretching of CH₃ | 2918 |
| | | 2960 |

Due to the high conductivity properties of COATING #A (or INK #A), it can be used as an effective EM shielding material. The shielding effectiveness isn't only affected by the material's conductivity but is also dependent on its thickness, as seen in Equation 1:

$$A ( dB ) \approx 8.7 \times t / δ \qquad ( 1 )$$

Where t is the sample thickness and δ the skin depth.

Hence 3 samples with 3 different thicknesses (˜108 μm (sample A), ˜154 μm (sample B) and ˜287 μm thick (sample C)) were produced on Mylar substrate. The S-parameters were extracted using a VNA from 100 MHz up to 3 GHZ, and the conductivity using a four-tip probe and sourcemeter.

TABLE 9
Conductivity and EM attenuation of coating composition of the present
disclosure samples - coating #A (or ink #A) samples

| Samples of | Thickness | Rsheet | Rbulk | EM absorption | EM reflection |
|---|---|---|---|---|---|
| coating #A | (μm) | (Ω/sq) | (Ω · cm) | (dB) | (dB) |
| A | 108.3 ± 6.2 | 61.0 ± 13.3 | 0.66 ± 0.14 | 12.5 ± 1.9 | 2.4 ± 0.7 |
| B | 153.8 ± 9.2 | 30.3 ± 2.9 | 0.47 ± 0.04 | 13.9 ± 1.8 | 2.2 ± 1.1 |
| C | 286.7 ± 16.3 | 15.2 ± 0.8 | 0.44 ± 0.02 | 20.9 ± 2.1 | 1.2 ± 0.7 |

From these measurements it is possible to observe a significant decrease, by half of the value of resistivity, from ˜61Ω/sq to ˜30Ω/sq by increasing the film thickness by around 50%, from ˜108 μm (sample A) to ˜154 μm (sample B). By further increasing the thickness to ˜287 μm (sample C) no significant changes were detected in bulk resistivity, but sheet resistance almost halved when compared to sample B.

In terms of EM shielding effectiveness, as expected, the increase of thickness reflected on an increase of the EM absorption value, reaching ˜22 dB for the thickest sample (C). This represents >99% attenuation of the electric field, a level above the appropriate requirements for most commercial applications. It is noteworthy that most of EM attenuation of COATING #A (or INK #A) is done through EM absorption and the amount of reflection lowers when sample thickness is increased, being this characteristic of conductive carbon-based materials, unlike metal shielding that mostly prevent the transmission of EM waves via reflection mechanisms, meaning it can still affect unprotected adjacent systems.

The bare Mylar substrate EM shielding properties were also measured, and no significant signal loss was detected, so the impact from substrate can be neglected.

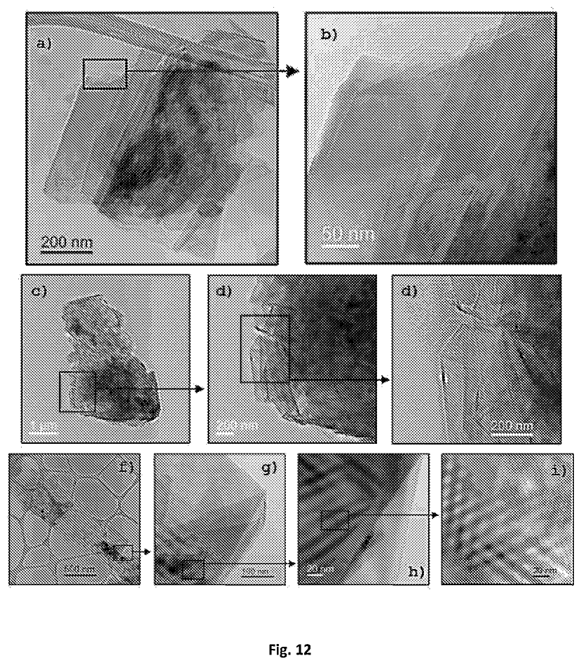

A plot of the data from Table 9 is better visualized in FIG. 11

In an embodiment, the composition of the present disclosure is suitable to be used as a coating to flexible or rigid materials, smooth or uneven surfaces, preferably an ink coating.

In an embodiment, the composition is used as a coating to industrial equipment, electronic parts, medical devices, communication devices, office devices, military devices, automotive components, aerospace and defence devices, EMI/RFI shielding enclosures, cables, RFID tags, solar panels, consumer electronics, mobile devices and flexible electronics, sensors, wearable electronics, touch screens.

In an embodiment, the composition is applied by spray coating, paint brushing, roll coating, spincoating, bladecoating, barcoating, doctor blade, dipcoating screen printing or dropcasting techniques.

TABLE 10
shows the application of the composition using different coating
techniques, as well as the thickness of the coatings.

| | | Rsheet |
|---|---|---|
| Technique | Thickness (μm) | (Ω/sq)² |
| Spraycoating | 15-25 | 600-1000 |
| Barcoating | 28-48 | <100-650 |
| Spincoating | For 500 rpm: 40-80 | 200-250 |
| | For 750 rpm: 22-36 | |
| Dropcasting | ~43 | <100 |

TABLE 11
Shows the results for ink composition samples using different
coating techniques as well as the thickness of the coatings.

| | Thickness | Rs | Bulk resistivity |
|---|---|---|---|
| Sample | (μm) | (Ω/sq) | (Ω/m) |
| Spray #1 | 17.1 ± 8.1 | 676.9 ± 111.1 | 1.16E−02 |
| Spray #2 | 21.0 ± 2.7 | 955.1 ± 168.8 | 2.01E−02 |
| Barcoating #1 | 28.9 ± 3.8 | 638.9 ± 45.2 | 1.85E−02 |
| Barcoating #3 | 33.7 ± 1.8 | 510.7 ± 74.8 | 1.7E−02 |
| Spincoating #1 | 39.9 ± 18.4 | 201.8 ± 4.5 | 8.05E−03 |
| Spincoating #2 | 21.6 ± 8.1 | 250.1 ± 29.1 | 5.39E−3 |
| Dropcasting | 43.5 ± 6.9 | 96.8 ± 24.3 | 4.20E−03 |

After applied, the composition can be air dry or be cured by heating at up to 250° C.

A method of applying the composition disclosed, comprises the coating composition, preferably ink,being applied as a coating by spray coating, paint brushing, roll coating, spincoating, bladecoating, barcoating, doctor blade, dipcoating screen printing or dropcasting, and then air dried or cured by heating at a temperature up to 250° C.

In one embodiment, the ink composition coating has a thickness between 15 and 20000 μm.

Where ranges are given, endpoints are included. Furthermore, it is to be understood that unless otherwise indicated or otherwise evident from the context and/or the understanding of one of ordinary skill in the art, values that are expressed as ranges can assume any specific value within the stated ranges in different embodiments of the invention, to the tenth of the unit of the lower limit of the range, unless the context clearly dictates otherwise. It is also to be understood that unless otherwise indicated or otherwise evident from the context and/or the understanding of one of ordinary skill in the art, values expressed as ranges can assume any subrange within the given range, wherein the endpoints of the subrange are expressed to the same degree of accuracy as the tenth of the unit of the lower limit of the range.

The term “comprising” whenever used in this document is intended to indicate the presence of stated features, integers, steps, components, but not to preclude the presence or addition of one or more other features, integers, steps, components or groups thereof.

It will be appreciated by those of ordinary skill in the art that unless otherwise indicated herein, the particular sequence of steps described is illustrative only and can be varied without departing from the disclosure. Thus, unless otherwise stated the steps described are so unordered meaning that, when possible, the steps can be performed in any convenient or desirable order.

This description is of course not in any way restricted to the embodiments presented herein and any person with an average knowledge of the area can provide many possibilities for modification thereof without departing from the general idea as defined by the claims.

The embodiments described above can be combined with each other. The following claims further define particular embodiments of the disclosure.

1. A graphene-based coating composition for electromagnetic interference shielding from 30 MHz to 300 GHz frequencies, comprising:
0.1 to 30 wt. % of graphene as a first carbon-based material;
0.1 to 30 wt. % of a second carbon-based conductive material;
0 to 20 wt. % of a dispersant agent;
0.1 to 40 wt. % of a polymer as a binder is selected from the group consisting of:
silicone-based polymer, polyetherimide, polysiloxane, polyethylenimine, ethylcellulose, an mixtures thereof;
0.1 to 10 wt. % of polyoxyethylene;
10 to 85 wt. % of a solvent is selected from the group consisting of: xylene, kerosene, toluene, water, dimethylsulfoxide, butanone, diethylene glycol monoethyl ether acetate, cirene, tetrahydrofuran, ethanol, polyacrylic acid, polyvinyl acid, terpineol, and mixtures thereof.

2. The composition according to claim 1, wherein the solvent ranges from 20 to 60 wt. %.

3. The composition according to claim 1, wherein the solvent is selected from the list consisting of: xylene, water, and mixtures thereof.

4. The composition according to claim 1, wherein the graphene is selected from the list consisting of: nanoplatelet graphene, few-layer graphene, multi-layer graphene, oxide graphene, and combinations thereof.

5. The composition according to claim 1, wherein the graphene is nanoplatelet graphene.

6. The composition according to claim 5, wherein the graphene nanoplatelets have a diameter particle size between 1 um and 25 μm.

7. The composition according to claim 5, wherein the graphene nanoplatelets have a D50 size of 2.0 μm and a D90 size of 7.8 μm.

8. The composition according to claim 1, wherein the graphene flake thickness is less than 100 nm.

9. The composition according to claim 1, wherein the amount the polymer ranges from 1 to 40 wt. %.

10. The composition according to claim 1, wherein the polymer is polysiloxane.

11. (canceled)

12. The composition according to claim 1, wherein the dispersant agent is alkoxysilane, and wherein the amount of alkoxysilane ranges from 0.1 to 20 wt. %.

13. The composition according to claim 1, wherein the second carbon-based conductive material is selected from the group consisting of: graphite, carbon black, carbon nanotubes, carbon nano onions, graphene oxide, carbon nanospheres, and mixtures thereof.

14. The composition according to claim 1, wherein the polyoxyethylene is polyoxyethylene 10 tridecyl ether.

15. The composition according to claim 1, wherein the dispersant agent is alkoxysilane, and wherein the alkoxysilane is (3-Aminopropyl)triethoxysilane.

16. (canceled)

17. A coated article, comprising the graphene-based coating composition according to claim 1 having a thickness on an exterior of the article.

18. Coated article according to claim 17 is an industrial equipment, electronic parts, medical devices, communication devices, office devices, military devices, automotive components, aerospace and defence devices, EMI/RFI shielding enclosures, cables, RFID tags, solar panels, consumer electronics, mobile devices and flexible electronics, sensors, wearable electronics, touch screens, in parasitic elements, board level shielding, patches and thin films.

19. The coated article according to claim 17, wherein the thickness of the coating composition ranges from 15 to 20000 μm.

20. The coated article of claim 17, wherein the thickness of the coating composition ranges from 100 to 250 μm.

21. A method for obtaining the graphene-based coating composition, comprising the steps of:
mixing of a polymeric binder—in a solvent;
adding graphene to the mixture;
adding a second carbon-based conductive material to the mixture; and adding polyoxyethylene to the mixture,
wherein
the polymer as a binder is selected from the group consisting of: silicone-based polymer, polyetherimide, polysiloxane, polyethylenimine, ethylcellulose, and their mixtures, and wherein the polymer as the binder ranges from 0.1 to 40 wt. %,
the graphene ranges from 1 to 30 wt. %,
the second carbon-based conductive material ranges from 0.1 to 30 wt. %,
the polyoxyethylene ranges from 0.1 to 10 wt. %, and
the solvent is selected from the list consisting of: xylene, kerosene, toluene, water, dimethylsulfoxide, butanone, diethylene glycol monoethyl ether acetate, cirene, tetrahydrofuran, ethanol, polyacrylic acid, polyvinyl acid, terpineol, and mixtures thereof, and wherein the solvent ranges from 10 to 85 wt. %.

22. The method according to claim 21, further comprising the step of adding a dispersant to the mixture.

23. A method for applying the graphene-based coating composition according to claim 1, comprising the steps of:
applying the coating composition to a substrate by one of: spray coating, paint brushing, roll coating, spincoating, bladecoating, barcoating, doctor blade, dipcoating screen printing and dropcasting techniques;
curing the coating layer by heating at a temperature up to 250° C.
